(19) United States
(12) Patent Application Publication
(10) Pub. No.: US 2009/0182300 A1
(43) Pub. Date: Jul. 16, 2009

(54) Drug Mixing Device

(75) Inventors: Bo Radmer, Hillerod (DK); Louise Charlotte Klok, Soborg (DK); Gunner Sie, Virum (DK)

Correspondence Address: NOVO NORDISK, INC.;INTELLECTUAL PROPERTY DEPARTMENT, 100 COLLEGE ROAD WEST, PRINCETON, NJ, 08540, US

(73) Assignee: Novo Nodisk A/S, Bagsvaerd (DK)

(21) Appl. No.: 12/281,382

(22) PCT Filed: Feb. 20, 2007
(86) PCT No.: PCT/EP2007/051607

§ 371 Date: Dec. 17, 2008

(30) Foreign Application Priority Data
Mar. 6, 2006 (EP) 06004452.6
Aug. 18, 2006 (EP) 06119150.8

(51) Int. Cl. A61J 1/20

(52) U.S. Cl. 604/411

(57) ABSTRACT

A drug mixing device (1) comprising at least two vial holders (4), at least one reservoir holder and means for establishing fluid connections between the reservoir holder (2) and the vial holders (4). Each of the vial holders (4) is adapted to receive a vial (5) containing a dry drug, such as a lyophilized drug, and each vial holder (4) comprises a hollow spike (9) adapted to penetrate a septum of a vial (5). Each of the reservoir holder (2) is adapted to receive a reservoir (3, 21) containing a liquid. Liquid can be provided from reservoir (3, 21) to vials (5) via an established fluid connection in order to reconstitute the dry drug. Each of the spikes (9) is provided with a stopping member (11) adapted to be in a first position in which a fluid passage is allowed, and a second position in which such passage is prevented.

### FIELD OF THE INVENTION

The present invention relates to a device for mixing drugs to be delivered to a human being. More particularly, the present invention relates to a drug mixing device for mixing a dry drug with a liquid, thereby obtaining a reconstituted drug.

### BACKGROUND OF THE INVENTION

For various reasons it is sometimes necessary or desirable to store a drug in dry form, such as in lyophilized form. This may, e.g., be in order to reduce degradation of the drug. Such dry drugs are normally stored in vials, and when the drug is to be delivered to a human it must be reconstituted, i.e. the dry drug must be mixed with a liquid. The reconstituted, liquid drug can then be administered to a person.

Sometimes a desired dose of the drug is larger than corresponding to the drug contained in a single vial. In this case the total dose must be composed using dry drug from two or more vials, the number of vials corresponding to the desired dose. This may, e.g., be done by sequentially applying a solvent liquid to each of the vials and retrieving the reconstituted drug to one common reservoir or syringe. When the drug of all of the vials has been reconstituted in this manner, the total dose may be administered to the person from the common reservoir or syringe. Reconstituting dry drug from two or more vials in this manner is, however, relatively time consuming. Furthermore, there is a risk of contamination of the drug due to the number of times a free opening will be exposed to free air or dirt.

It is therefore desirable to provide a drug mixing device which facilitates mixing a dose using dry drug from two or more vials, and which reduces the risk of contamination of the resulting drug.

Systems for mixing parenteral nutrition solutions from additives in a plurality of vials containing the additives are known. One such system is disclosed in U.S. Pat. No. 5,037,390. The vials are positioned on a rack where a vented spike is inserted in each vial. A dedicated syringe is connected with each vial in aligned relationship therewith through a two-way valve which is mounted to a manifold. Drug from each vial is sequentially pulled into the manifold and delivered to a container where the additives are mixed. Since the vials in this case contain liquid drug the problem of easily and quickly providing solvent liquid to a number of vials containing dry drug is not addressed in U.S. Pat. No. 5,037,390. Furthermore, the retrieval of the drugs from the vials is still performed sequentially, even though the risk of contamination of the resulting drug is reduced.

### SUMMARY OF THE INVENTION

It is, thus, an object of the invention to provide a drug mixing device for reconstituting dry drug from two or more vials to form a single dose, the device reducing the risk of contamination of the resulting drug as compared to prior art devices.

It is a further object of the invention to provide a drug mixing device for reconstituting dry drug from two or more vials to form a single dose in a manner which is less time consuming than is the case in prior art devices.

According to a first aspect of the invention the above and other objects are fulfilled by providing a drug mixing device comprising:
at least two vial holders, each being adapted to receive a vial containing a dry drug, each vial holder comprising a hollow spike adapted to penetrate a septum of a vial, thereby establishing a fluid connection to the interior of the vial,
at least one reservoir holder being adapted to receive a reservoir containing a liquid, and
means for establishing fluid connections between the reservoir holder(s) and the vial holders, thereby providing liquid from reservoir(s) positioned in the reservoir holder(s) for vials positioned in the vial holders,
wherein each of the spikes of the vial holders is provided with a stopping member adapted to be in a first position in which a fluid is allowed to pass through the corresponding spike, and a second position in which such passage is prevented, and wherein each of the stopping members is adapted to be moved from the second position to the first position by a vial being received in a corresponding vial holder.

According to a second aspect of the invention the above and other objects are fulfilled by providing a method for reconstituting dry drugs, the method comprising the steps of:
providing a reservoir containing a liquid,
providing two or more vials, each containing a dry drug,
simultaneously transferring liquid from the reservoir to each of the vials, and
reconstituting the dry drug in each of the vials.

It should be noted that a person skilled in the art would readily recognise that any feature described in combination with the first aspect of the invention could also be combined with the second aspect of the invention, and vice versa.

The drug mixing device comprises at least two vial holders. In the present context the term ‘vial holder’ should be interpreted to mean a device or a member in which a vial can be positioned in such a manner that it is possible to gain access to the contents of the vial. It may, for instance, simply be a hollow spike adapted to penetrate a septum of a vial. Alternatively it may be a vial adapter. Since the drug mixing device comprises at least two vial holders, and since each vial holder is adapted to receive a vial, it is possible to position at least two vials at the drug mixing device simultaneously, and it is possible to simultaneously gain access to the contents of each vial which may be positioned in the vial holders. It should, however, be noted, that it is possible to use fewer vial holders than the available number of vial holders, and it is also possible to sequentially position vials in the same vial holder. If the drug mixing device comprises, e.g., four vial holders, it is possible to use only one, two or three of them at a time. It should also be noted, that in case only one vial is needed, it is, of course, possible to position one vial in one of the vial holders. In case not all of the vial holders are used, it should, however, be ensured that no liquid can spill from the vial holders which are not in use. This will be further described below. Furthermore, each vial holder comprises a hollow spike adapted to penetrate a septum of a vial. The hollow spike is used for establishing a fluid connection to the interior of the vial. The hollow spikes are preferably positioned at the vial holders in such a way that when a vial is positioned in a vial holder, the septum of the vial is thereby penetrated by the hollow spike, and a fluid connection to the interior of the vial is thereby established as the vial is being positioned in the vial holder. Alternatively, the hollow spikes may, e.g. for security reasons, be hidden or covered in such a way, that when a vial has been positioned in a vial holder, the hollow spike must be separately and actively moved or activated in order to penetrate the septum of the vial.

The drug mixing device comprises at least one reservoir holder, each being adapted to receive a reservoir containing a liquid. In the present context the term ‘reservoir holder’ should be interpreted to mean a device or a member in which a reservoir can be positioned in such a manner that it is possible to gain access to the contents of the reservoir, in this case the liquid contained in the reservoir. The liquid contained in the reservoir is preferably a solvent liquid being suitable for reconstituting a dry drug contained in a vial positioned in one of the vial holders. The reservoir may be any suitable kind of reservoir, such as a syringe, a vial, a container, a flexible reservoir, such as a bag, etc.

The drug mixing device comprises means for establishing fluid connections between the reservoir holder(s) and the vial holders, thereby providing liquid from reservoir(s) positioned in the reservoir holder(s) for vials positioned in the vial holders. Accordingly, dry drug in the vials is reconstituted using liquid from the reservoir(s). This may, e.g., be done by providing liquid from one reservoir to each of the vials, or by providing liquid from reservoirs to vials in a ‘one-to-one configuration’ where each reservoir is associated with a vial and vice versa. This will be explained further below.

Each of the spikes of the vial holders is provided with a stopping member adapted to be in a first position in which a fluid is allowed to pass through the corresponding spike, and a second position in which such passage is prevented. Each of the stopping members is adapted to be moved from the second position to the first position by a vial being received in a corresponding vial holder. Thus, in case the number of vials needed or desired is lower than the number of available vial holders, the stopping members provided on the vial holders which are not in use are preferably in the second state, while the stopping members of the vial holders which are in use are preferably in the first state. Thereby, the stopping members of the vial holders which are not in use will prevent that liquid from the reservoir(s) leaves the drug mixing device via these vial holders. Furthermore, the stopping members of the vial holders which are in use may preferably ensure that, on the one hand, all of the vials positioned at the vial holders will receive liquid from the reservoir(s), and, on the other hand, all of the liquid from the reservoir(s) will enter a vial.

The stopping members may advantageously be manufactured from a rubber material, e.g. silicon rubber, thermoplastic elastomers (TPE), or any other suitable kind of rubber material.

The stopping members are physically moved by a vial when they are switched between the first and second states.

The stopping members are positioned in the vial holders in such a manner, that when a vial is positioned in a vial holder, the corresponding stopping member is automatically moved to the first position, thereby establishing a fluid connection to the interior of the vial being positioned in the vial holder. Similarly, when the vial at a later time is removed from the vial holder, the stopping member may automatically be moved to the second position, thereby preventing further passage of fluid via the hollow spike. Thereby it is ensured that it is always possible for liquid from the reservoir(s) to enter a vial positioned in a vial holder, and at the same time it is ensured that liquid from the reservoir(s) does not leave the drug mixing device via vial holders where no vials are positioned. Alternatively, it may not be possible to move a stopping member back to the second position once it has been moved to the first position. The stopping members may, e.g., be physically moved by means of the vial, e.g. pushed by the vial, between the first and second positions. Alternatively, positioning or removing a vial in/from a vial holder may activate a mechanism which moves the corresponding stopping member between the first and second positions.

The means for establishing fluid connections may comprise manifold means. This may be obtained by letting the reservoir holder(s) fluidly communicate with a manifold, i.e. a reservoir, a compartment, a pipe or the like which is further fluidly connected to a number of parallel flow paths, each being fluidly connected to a vial holder. Such an arrangement may, e.g., be in the form of a ‘pooling fork’. In this case the drug mixing device will have a shape which is similar to the shape of a fork with the reservoir holder(s) positioned where the handle of the fork would be, and each of the flow paths to the vial holders constituting the teeth of the fork with the vial holders at the tips of the teeth.

The drug mixing device may comprise only one reservoir holder, and the means for establishing fluid connections may be adapted to simultaneously establish fluid connections between a reservoir positioned in the reservoir holder and two or more vials positioned in the vial holders.

Thus, according to this embodiment, when two or more vials are positioned in the vial holders and a reservoir is positioned in the reservoir holder, it is possible to simultaneously transfer liquid from the reservoir to each of the vials. Thereby dry drug in all of the vials can be simultaneously reconstituted, and time is thereby saved. Furthermore, since it is not necessary to move the reservoir during reconstitution of the dry drug in the vials, the risk of contamination of the resulting liquid drug is considerably reduced. This is very advantageous. The fluid connections may be established as parallel flow paths between the reservoir holder and each of the vial holders.

The method according to the second aspect of the invention may further comprise the step of:
simultaneously retrieving the reconstituted drug from each of the vials to a common reservoir.

According to this embodiment, when the drug of each of the vials has been reconstituted, the reconstituted drug is retrieved from all of the vials simultaneously to a common reservoir. Thus, the common reservoir will contain a dose of drug which corresponds to the drug contained in all of the vials, i.e. a combined dose. Thus, the drug from all of the vials has been ‘pooled’. The common reservoir may be the reservoir. In this case the reconstituted drug may simply be pulled back into the reservoir, e.g. being in the form of a syringe. The reservoir containing the reconstituted drug may subsequently be removed from the reservoir holder, and the dose may then be delivered to a person directly from the reservoir/syringe.

Alternatively, the device may comprise at least two reservoir holders, each being adapted to receive a reservoir containing a liquid, and each being associated with a vial holder. In this case the means for establishing fluid connections may advantageously be adapted to establish fluid connections between each reservoir holder and its associated vial holder. According to this embodiment each reservoir is associated with a vial, and vice versa. Accordingly, pairs of vials and reservoirs form ‘dedicated units’.

The device may further comprise means for establishing a common fluid connection between each of the vial holders and an outlet, and/or the device may further comprise means for forcing liquid from a reservoir into a vial via an established fluid connection.

The device may further comprise at least one vial and at least one reservoir, and a reservoir, a vial, the means for establishing a fluid connection between the reservoir and the vial, and the forcing means may form an integral unit. According to this embodiment, a desired number of such units may be inserted into the device, thereby allowing a user to constitute a dose of a desired amount. Thus, the device may comprise a plurality of such integral units and/or one or more of said integral units may contain different amounts of dry drug and/or liquid than other units. This will allow a user to specifically design the amount of the dose.

According to a third aspect of the invention, the above objects and other objects are achieved by a drug mixing device comprising;
at least two vials containing a dry drug, such as a lyophilized drug,
at least one vial holder adapted to receive one of said vials,
a reservoir containing a liquid, and
means for establishing fluid connections between the reservoir and the at least one vial holder, thereby providing liquid from the reservoir to the vial positioned in the at least one vial holder.

The vials may be positioned adjacent to each other and in a manner so that they can be moved one by one to the at least one vial holder for establishing fluid connection between the reservoir and a vial positioned in the vial holder.

The at least one vial holder may comprise a hollow spike adapted to penetrate a septum of a vial, thereby establishing a fluid connection to the interior of the vial.

The vials may be positioned in a rotatable part of the device, which rotates the plurality of vials until one of the vials is positioned over the vial holder. The vial can then be pushed into the holder so that the spike penetrates a septum of the vial. If the user needs more drug than what is contained in one vial, the used vial can be removed from the vial holder, and the rotatable part is rotated until the next vial is positioned over the holder and so forth.

Instead of moving the vials to one single vial holder, the device may comprise two or more vial holders, such as a vial holder for each vial, and the means for establishing fluid connections may be adapted to simultaneously establish fluid connections between the reservoir and each of the vial holders, thereby simultaneously providing liquid from the reservoir to two or more vials positioned in the vial holders.

The reservoir may be an integrated part of the device.

According to a fourth aspect, the above objects and other objects are fulfilled by a drug mixing device comprising;
a plurality of vials, each containing dry drug, such as lyophilized drug,
a plurality of reservoirs, each containing liquid and being associated with a vial,
means for establishing fluid connections between a vial and a reservoir for providing liquid from the reservoir into the vial for reconstituting said drug, and
means for establishing a common fluid connection between the vials containing the reconstituted drug and an outlet.

The device may further comprise means for forcing the liquid from a reservoir to a vial via an established fluid connection.

A reservoir, a vial, the means for establishing the fluid connection between the reservoir and vial, and the forcing means preferably form an integral unit, and the device may comprise a plurality of such integral units.

One or more of said integral units may contain different amount of dry drug and/or liquid than others. Thus, one single device can be made with a specific dedicated amount of drug for the individual users by adding two or more vials in the device.

When a personal dose of reconstituted drug is different from a standard size of a vial, the user needs to combine the actual dose from two or more vials, and in this case the reconstitution procedure is much more complicated and dosage of the total dose involves reloading into one large syringe or infusion from several small syringes.

The invention according to the first, second, third and fourth aspect solves this problem by providing the possibility of having a plurality of vials in the same mixing device, which has the advantage that the user can get more drug than what normally is contained in one vial by use of the same device, and the device can contain a specific dedicated amount of drug for the user by combining a number of standard vial sizes. Furthermore, the user only needs to reconstitute once to get the personal dose, which is much more convenient for the user.

Furthermore, the number of variants of vials containing different amounts of drug can be reduced, as the user can get the dedicated amount by adding together two or more vials containing a standard amount. This is an advantage both for the user, but also for the manufacturer as the number of variants are reduced which results in reduced manufacturing costs.

It should be noted that a person skilled in the art would readily recognise that any feature described in combination with the first and second aspect of the invention could also be combined with the third and fourth aspect of the invention, and vice versa.

### BRIEF DESCRIPTION OF THE DRAWINGS

The invention will now be described in further details with reference to the accompanying drawings in which

FIG. 1 is a perspective view of a drug mixing device according to a first embodiment of the invention, and

FIG. 2 is a cross sectional view of a vial holder provided with a stopping member,

FIG. 3 shows a perspective view of a drug mixing device according to a second embodiment of the invention, and

FIGS. 4a-4c show a drug mixing device according to a third embodiment of the invention.

### DETAILED DESCRIPTION OF THE DRAWINGS

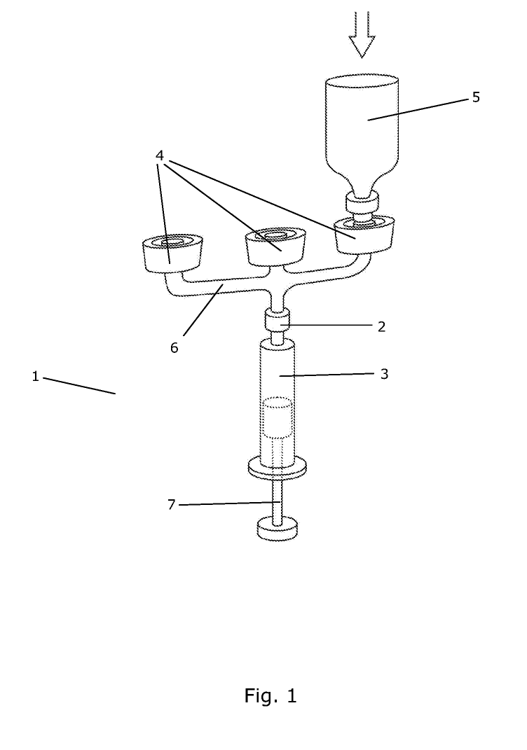

FIG. 1 is a perspective view of a drug mixing device 1 according to a first embodiment of the invention. The drug mixing device 1 comprises a reservoir holder 2 with a reservoir in the form of a syringe 3 positioned therein. The drug mixing device 1 further comprises three vial holders 4, one of the vial holders 4 having a vial 5 positioned therein. Other vials may be similarly positioned in the remaining two vial holders 4. The reservoir holder 2 is connected to each of the vial holders 4 via pipe 6. The pipe 6 is shaped as a fork with the reservoir holder 2 positioned where the handle of the fork would normally be, and the vial holders 4 positioned where the teeth of the fork would normally be.

The drug mixing device 1 of FIG. 1 is preferably operated in the following manner. A syringe 3 containing a liquid is positioned in the reservoir holder 2. One, two or three vials 5, depending on the desired dose, is/are positioned in the vial holders 4. Each vial 5 comprises a dry drug. In case only one or two vials 5 is/are used, it should be ensured that no liquid can leave the drug mixing device 1 via the remaining vial holder(s) 4. A piston 7 of the syringe 3 is then moved upwards. Thereby the liquid in the syringe 3 is pressed out of the syringe 3, into the pipe 6 and further into each of the vials 5. The dry drug in the vial(s) 5 is then reconstituted by means of the liquid. Due to the geometry of the pipe 6, liquid is transferred simultaneously from the syringe 3 to each of the vials 5. When the drug in the vial(s) 5 has been reconstituted, the piston 7 is moved downwards. Thereby reconstituted drug is transferred simultaneously from each of the vials 5 to the syringe 3. The syringe 3 then contains a dose of reconstituted drug corresponding to the dry drug contained in all of the vials 5 which were initially positioned in the vial holders 4.

The syringe 3 containing the complete dose of reconstituted drug may subsequently be removed from the reservoir holder 2, and the dose may be delivered to a person directly from the syringe 3.

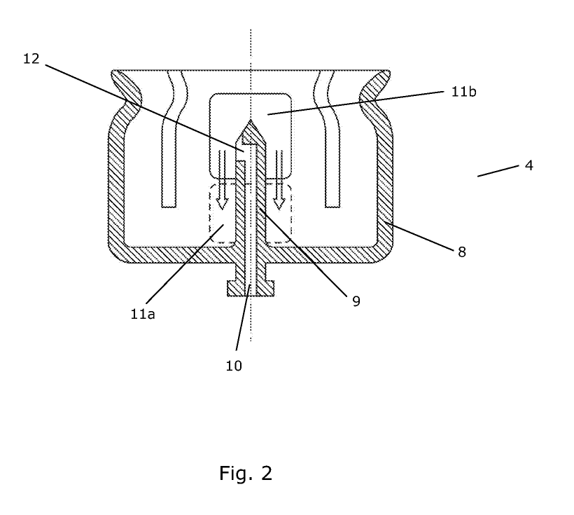

FIG. 2 is a cross sectional view of a vial holder 4 for a drug mixing device 1 according to an embodiment of the invention. The vial holder 4 comprises a holding part 8 adapted to hold a vial by snap fitting to a collar portion of the vial. The vial holder 4 is further provided with a spike 9 with a through-going hollow channel 10. When a vial is positioned in the vial holder 4, the spike 9 will penetrate the septum of the vial, and the through-going hollow channel 10 will provide a fluid connection through the septum to the interior of the vial. It should be noted that, as an alternative to the vial holder 4 shown in FIG. 2, a vial holder simply in the form of a hollow spike may be used, i.e. the holding part 8 may be omitted.

The spike 9 is provided with a movable stopping member 11. In FIG. 2 the stopping member 11 is shown in two positions. In a first position illustrated with a dashed line, the stopping member 11a allows fluid passage through the through-going hollow channel 10. In a second position illustrated with a full line, the stopping member 11b prevents such passage, since the stopping member 11b is in this case positioned in a manner which blocks an opening 12 of the through-going hollow channel 10.

When no vial is positioned in the vial holder 4 the stopping member 11 will be in the second position, i.e. preventing fluid passage through the through-going hollow channel 10. When a vial is being positioned in the vial holder 4, the stopping member 11 is pushed to the first position. Thereby it is automatically ensured that liquid is allowed to pass via the through-going hollow channel 10 when a vial is present in the vial holder 4. When the vial is subsequently removed from the vial holder 4, the stopping member 11 will remain in the first position. Thus, the vial holder 4 of FIG. 2 is not suitable for re-use, and the device which it forms part of is preferably a disposable device.

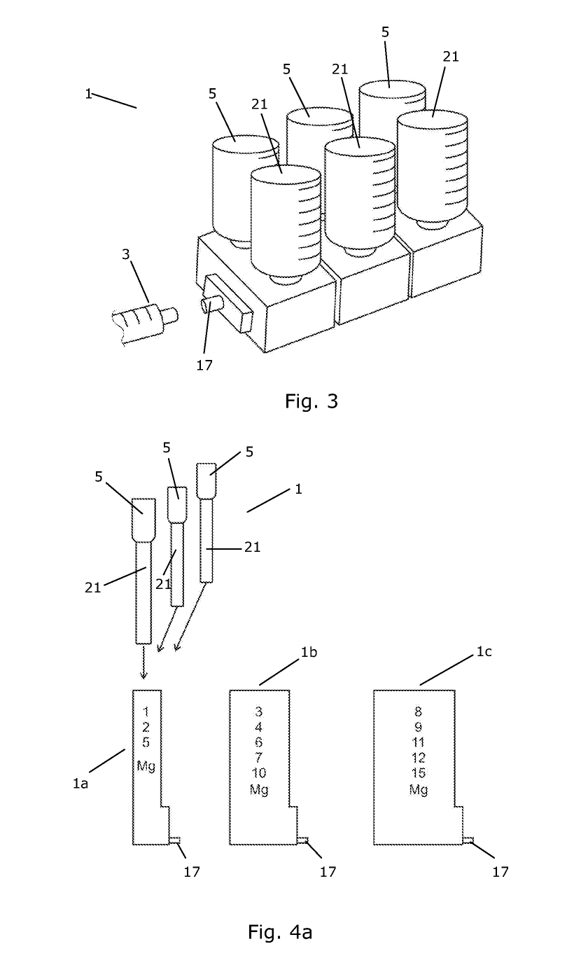

FIG. 3 shows a second embodiment of a mixing device 1 according to the invention. The device 1 comprises a plurality of vials 5 containing dry drug and a plurality of reservoirs 21 containing liquid. The dry drug is reconstituted by forcing liquid from the reservoir 21 into the vial 5 by pressure provided in the reservoir 21 and/or by vacuum provided in the vial 5. Alternatively, the liquid can be forced into the vials 5 via a syringe 3, which is connected to an outlet 17. A common fluid connection may establish connection between the outlet 17 and each of the reservoirs 21 and vials 5. Thus, it is possible for the user to reconstitute from three vials 4 by use of one single device 1 and via one common outlet 17 with only one syringe 3.

The device of FIG. 3 may comprise vial and reservoir holders (not shown) having a holding part adapted to hold a vial and reservoir by snap fitting to a collar portion of the vial and reservoir, respectively. The holder is further provided with a spike with a through-going hollow channel. When a vial and reservoir is positioned in the holder, the spike will penetrate the septum of the vial and reservoir, respectively, and the through-going hollow channel will provide a fluid connection through the septum to the interior of the vial and reservoir, respectively. The spike is provided with a movable stopping member as described above.

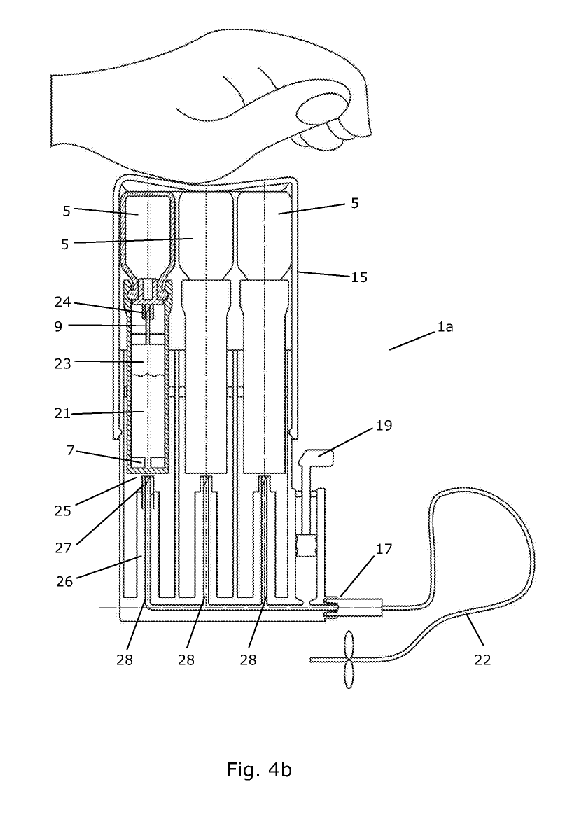

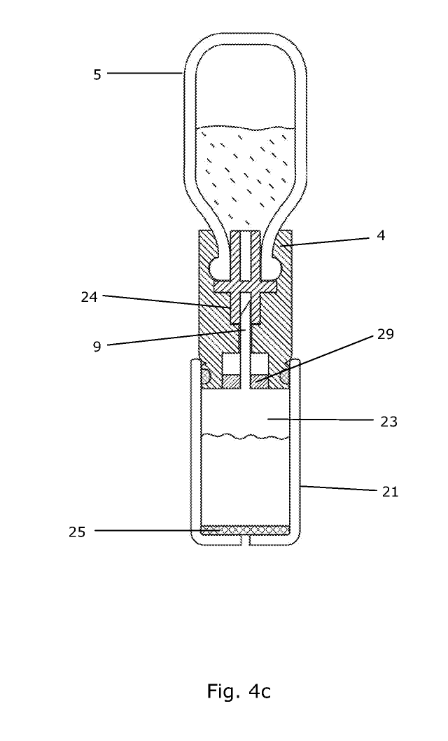

FIG. 4a shows three drug mixing units 1a, 1b and 1c, each containing a plurality of mixing units 1 (shown outside the mixing unit 1a). Each mixing unit 1 comprises a vial 5 with dry drug and a reservoir 21 with liquid. The mixing units 1a, 1b and 1c each has dedicated amounts of drug; 1a has three mixing units with 1, 2 and 5 milligram, 1b has five mixing units with 3, 4, 6, 7 and 10 milligram, and 1c has five mixing units with 8, 9, 11, 12 and 15 milligram. These drug amounts are only examples.

Each mixing unit 1a, 1b and 1c has a common outlet 17, which can be connected to a syringe or infusion needle 22.

FIG. 4b shows a cross sectional view of the mixing unit 1a shown in FIG. 4a. The mixing unit comprises three mixing units 1 consisting of a vial 5, a reservoir 21 for liquid and air 23, a spike 9 for establishing fluid connection between the reservoir 21 and vial 5. The reservoir 21 is sealed by a seal 24 placed in the spike 9 and a seal 25 provided in the bottom of the reservoir 21.

The spike 9 penetrates the seal 24 and the septum of the vial 5, when the top part 15 is pressed downwards, e.g. manually by a hand as shown, and a fluid connection between the reservoir 21 and vial 5 is established in the mixing units 1. By pressing the top part 15 further downwards, the plunger 7 will force liquid into the vial 5, as the reservoir 21 is pressed down over the pin 26. The drug in the vial 5 will now be reconstituted, and the fluid connection from the vial 5 to the common outlet 17 will be established by pressing the top part 15 further downwards until the seal 27 is penetrated by a spike provided in the end of the pin 26. The reconstituted drug from the vials 5 can now be infused directly via the injection needle 22 via the fluid connections 28—the drug will flow automatically due to the pressure provided in the vials 5.

The device further comprises a suction unit 19 for aspiration prior to infusion.

FIG. 4c shows a mixing unit 1 of FIG. 4b more in detail. The mixing unit 1 comprises a vial 5, a reservoir 21 with liquid and air 23, a seal 25 in the bottom of the reservoir 21, a seal 24 over the spike 9 and a spike plunger 29, which moves the spike 9 through the seal 24 when being forced by the liquid. The vial 5 is placed in a vial holder 4.

1. A drug mixing device comprising:
at least two vial holders, each being adapted to receive a vial containing a dry drug, each vial holder comprising a hollow spike adapted to penetrate a septum of a vial, thereby establishing a fluid connection to the interior of the vial,
at least one reservoir holder being adapted to receive a reservoir containing a liquid, and
means for establishing fluid connections between the reservoir holder(s) and the vial holders, thereby providing liquid from reservoir(s) positioned in the reservoir holder(s) for vials positioned in the vial holders,
wherein each of the spikes of the vial holders is provided with a stopping member adapted to be in a first position in which a fluid is allowed to pass through the corresponding spike, and a second position in which such passage is prevented, and wherein each of the stopping members is adapted to be moved from the second position to the first position by a vial being received in a corresponding vial holder.

2. A device according to claim 1, wherein the means for establishing fluid connections comprises manifold means.

3. A device according to claim 1, wherein the device comprises only one reservoir holder, and wherein the means for establishing fluid connections is adapted to simultaneously establish fluid connections between a reservoir positioned in the reservoir holder and two or more vials positioned in the vial holders.

4. A device according to claim 1, wherein the device comprises at least two reservoir holders, each being adapted to receive a reservoir containing a liquid, and each being associated with a vial holder, and wherein the means for establishing fluid connections is adapted to establish fluid connections between each reservoir holder and its associated vial holder.

5. A device according to claim 4, further comprising means for establishing a common fluid connection between each of the vial holders and an outlet.

6. A device according to claim 4, further comprising means for forcing liquid from a reservoir into a vial via an established fluid connection.

7. A device according to claim 6, further comprising at least one vial and at least one reservoir, and wherein a reservoir, a vial, the means for establishing a fluid connection between the reservoir and the vial, and the forcing means form an integral unit.

8. A device according to claim 7, wherein the device comprises a plurality of integral units.

9. A device according to claim 8, wherein one or more of said integral units contains different amounts of dry drug and/or liquid than other units.

10. A device according to claim 2, wherein the device comprises only one reservoir holder, and wherein the means for establishing fluid connections is adapted to simultaneously establish fluid connections between a reservoir positioned in the reservoir holder and two or more vials positioned in the vial holders.

11. A device according to claim 2, wherein the device comprises at least two reservoir holders, each being adapted to receive a reservoir containing a liquid, and each being associated with a vial holder, and wherein the means for establishing fluid connections is adapted to establish fluid connections between each reservoir holder and its associated vial holder.

12. A device according to claim 11, further comprising means for establishing a common fluid connection between each of the vial holders and an outlet.

13. A device according to claim 12, further comprising means for forcing liquid from a reservoir into a vial via an established fluid connection.

14. A device according to claim 13, further comprising at least one vial and at least one reservoir, and wherein a reservoir, a vial, the means for establishing a fluid connection between the reservoir and the vial, and the forcing means form an integral unit.

15. A device according to claim 14, wherein the device comprises a plurality of integral units.

16. A device according to claim 15, wherein one or more of said integral units contains different amounts of dry drug and/or liquid than other units.

17. A device according to claim 12, further comprising means for forcing liquid from a reservoir into a vial via an established fluid connection.

18. A device according to claim 17, further comprising at least one vial and at least one reservoir, and wherein a reservoir, a vial, the means for establishing a fluid connection between the reservoir and the vial, and the forcing means form an integral unit.

19. A device according to claim 18, wherein the device comprises a plurality of integral units.

20. A device according to claim 19, wherein one or more of said integral units contains different amounts of dry drug and/or liquid than other units.
